(19) United States
(12) Patent Application Publication
(10) Pub. No.: US 2023/0276298 A1
(43) Pub. Date: Aug. 31, 2023

(54) Selecting Mitigation Strategy for Cell Overload

(71) Applicant: Telefonaktiebolaget LM Ericsson (publ), Stockholm (SE)

(72) Inventors: Athanasios Karapantelakis, Solna (SE); Marin Orlic, Bromma (SE); Kristijonas Cyras, San Jose, CA (US); Leonid Mokrushin, Uppsala (SE); Jörg Niemöller, Sollentuna (SE)

(21) Appl. No.: 18/012,300

(22) PCT Filed: Jun. 24, 2020
(86) PCT No.: PCT/SE2020/050652

§ 371 Date: Dec. 22, 2022

(51) Int. Cl. H04W 28/02

(52) U.S. Cl. CPC H04W 28/0289; H04W 28/0284

(57) ABSTRACT

The present disclosure relates to methods and devices (14, 20) for enabling mitigation of radio traffic overload in at least one radio cell (19) among a group of radio cells (17, 18, 19). In an aspect, a method of a supervising device (20) of enabling mitigation of radio traffic overload in at least one radio cell (19) among a group of radio cells (17, 18, 19) is provided. The method comprises acquiring (S101a-c) a radio traffic capacity utilization metric of each of the group of radio cells (17, 18, 19), acquiring (S104a-c) a proposed measure to be taken for mitigating radio traffic overload of said at least one radio cell (19) from a device (14) serving said at least one radio cell (19) and from a device (12, 13) serving at least one of its neighbouring radio cells (17, 18) in the group, determining (S105), based on the acquired radio traffic capacity utilization metrics and the acquired proposed measures to be taken, a selected measure to be taken for mitigating radio traffic overload of said at least one radio cell (19), and instructing (S106) the device (14) serving said at least one radio cell to apply the selected measure for mitigating radio traffic overload of said at least one radio cell (19).

### TECHNICAL FIELD

The present disclosure relates to methods and devices for enabling mitigation of radio traffic overload in at least one radio cell among a group of radio cells.

### BACKGROUND

In the art, radio traffic overload continuously occurs in radio cells at a radio site in a mobile network. Specifically, in 5^{th} Generation (5G) mobile networks, different types of services such as critical machine type, ultra-reliable low latency and mobile broadband communication that have different quality of service (QoS) requirements will be operating concurrently in the network. Radio traffic overload can normally be observed and is to be dealt with at run-time, or can be predicted to happen in the future and then be pre-empted. In any case, strategies need to be devised to handle radio traffic overload.

Several approaches can be used for resolving either current or predicted traffic overload events. One technique offloads main (or macro cell) traffic to a nearby small cell by means of a wireless communication device, commonly referred to as user equipment (UE), performing a handover from the macro cell to the smaller cell.

Another approach changes spectrum sharing ratio between network slices (i.e. network entities formed by dividing a network into flexible and scalable slices having a subset of the capacity of the total network), e.g. borrowing spectrum to one slice from another under-utilized slice, or from another radio access technology. Still another approach changes uplink-to-downlink ratio based on UE data consumption patterns, e.g. if a UE is receiving more data than it is sending, more bandwidth is allocated to the downlink (DL) rather than to the uplink (UL).

However, the approaches utilized for mitigating the cell overload situations are performed on a cell-by-cell basis. This has two main shortcomings. Firstly, this results in sub-optimization for the situation a cell is in. For example, constantly offloading UEs to a nearby small cell or neighbouring macro-cell will require repeated UE handover, when a change in UL/DL ratio may be a better choice.

Secondly, systemic effects of the decision for the data traffic overload are not taken into account as every cell unilaterally decides for itself which approach to select and does not coordinate its decision with other cells in the vicinity that may also be affected by the selected approach for mitigating traffic overload.

### SUMMARY

An objective is to solve, or at least mitigate, this problem in the art and to provide an improved method of enabling mitigation of radio traffic overload in a radio cell.

This objective is attained in a first aspect by a method of a supervising device of enabling mitigation of radio traffic overload in at least one radio cell among a group of radio cells. The method comprises acquiring a radio traffic capacity utilization metric of each of the group of radio cells, acquiring a proposed measure to be taken for mitigating radio traffic overload of said at least one radio cell from a device serving said at least one radio cell and from a device serving at least one of its neighbouring radio cells in the group, determining, based on the acquired radio traffic capacity utilization metrics and the acquired proposed measures to be taken, a selected measure to be taken for mitigating radio traffic overload of said at least one radio cell, and instructing the device serving said at least one radio cell to apply the selected measure for mitigating radio traffic overload of said at least one radio cell.

This objective is attained in a second aspect by a supervising device configured to enable mitigation of radio traffic overload in at least one radio cell among a group of radio cells, the supervising device comprising a processing unit and a memory, said memory containing instructions executable by said processing unit, whereby the supervising device is operative to acquire a radio traffic capacity utilization metric of each of the group of radio cells, acquire a proposed measure to be taken for mitigating radio traffic overload of said at least one radio cell from a device serving said at least one radio cell and from a device serving at least one of its neighbouring radio cells in the group, determine, based on the acquired radio traffic capacity utilization metrics and the acquired proposed measures to be taken, a selected measure to be taken for mitigating radio traffic overload of said at least one radio cell, and instruct the device serving said at least one radio cell to apply the selected measure for mitigating radio traffic overload of said at least one radio cell.

This objective is attained in a third aspect by a method of a supervising device of enabling mitigation of radio traffic overload in at least one radio cell among a group of radio cells. The method comprises acquiring a radio traffic capacity utilization metric of each of the group of radio cells, determining, based on the acquired radio traffic capacity utilization metrics from said at least one radio cell from a device serving said at least one radio cell and from a device serving at least one of its neighbouring radio cells in the group, a measure to be taken for mitigating radio traffic overload of said at least one radio cell, and instructing the device serving said at least one radio cell to apply the determined measure for mitigating radio traffic overload of said at least one radio cell.

This objective is attained in a fourth aspect by a supervising device configured to enable mitigation of radio traffic overload in at least one radio cell among a group of radio cells, the supervising device comprising a processing unit and a memory, said memory containing instructions executable by said processing unit, whereby the supervising device is operative to acquire a radio traffic capacity utilization metric of each of the group of radio cells, determine, based on the acquired radio traffic capacity utilization metrics from said at least one radio cell from a device serving said at least one radio cell and from a device serving at least one of its neighbouring radio cells in the group, a measure to be taken for mitigating radio traffic overload of said at least one radio cell, and to instruct the device serving said at least one radio cell to apply the determined measure for mitigating radio traffic overload of said at least one radio cell.

This objective is attained in a fifth aspect by a method of a device serving at least one radio cell of enabling mitigation of radio traffic overload in said at least one radio cell among a group of radio cells. The method comprises receiving, from a supervising device, a request for a proposed measure to be taken for mitigating radio traffic overload of said at least one radio cell, acquiring a radio traffic capacity utilization metric of at least one neighbouring radio cell, acquiring a proposed measure to be taken for mitigating radio traffic overload of said at least one radio cell from a device serving at least one neighbouring radio cell, determining, a measure to be taken for mitigating radio traffic overload of said at least one radio cell, determining, based on the acquired radio traffic capacity utilization metric, the acquired proposed measure to be taken for the at least one neighbouring cell and the determined measure to be taken for said at least one radio cell, a selected measure to be taken for mitigating radio traffic overload of said at least one radio cell, and applying the selected measure for mitigating radio traffic overload of said at least one radio cell.

This objective is attained in a sixth aspect by a device serving at least one radio cell being configured to enable mitigation of radio traffic overload in said at least one radio cell among a group of radio cells, the device comprising a processing unit and a memory, said memory containing instructions executable by said processing unit, whereby the device is operative to receive, from a supervising device, a request for a proposed measure to be taken for mitigating radio traffic overload of said at least one radio cell, acquire a radio traffic capacity utilization metric of at least one neighbouring radio cell, acquire a proposed measure to be taken for mitigating radio traffic overload of said at least one radio cell from a device serving at least one neighbouring radio cell, determine, a measure to be taken for mitigating radio traffic overload of said at least one radio cell, determine, based on the acquired radio traffic capacity utilization metric, the acquired proposed measure to be taken for the at least one neighbouring cell and the determined measure to be taken for said at least one radio cell, a selected measure to be taken for mitigating radio traffic overload of said at least one radio cell, and to apply the selected measure for mitigating radio traffic overload of said at least one radio cell.

Advantageously, by collecting measures to be taken from different neighbouring cells for mitigating radio traffic overload of a given radio cell—referred to herein as mitigation strategies—a best cell overload-mitigation strategy is determined given actual circumstances as indicated by reported radio traffic capacity utilization metrics from the cells rather than necessarily selecting the mitigation strategy proposed by the device serving the cell of which is subjected to overload. As a result, an informed decision is taken on the best strategy to apply.

Further advantageous is timing; the devices serving the cells may propose measures to be taken for mitigating radio traffic overload even without an indication of an imminent traffic overload event, but instead proactively create mitigation strategies, thereby providing readiness once an overload event occurs.

Advantageously, in contrast to a fully centralized approach for creating mitigation strategies, the embodiments disclosed herein allows for decentralized mitigation strategy creation thus enabling geofencing if needed: individual cells or cell groups need not disclose sensitive information to either other cells or a central entity, but instead share proposed hypothetical mitigation strategies.

In an embodiment, the acquiring of a proposed measure to be taken for mitigating radio traffic overload of said at least one radio cell comprises sending a request, to the device serving said at least one radio cell and to the device serving said at least one neighbouring cell for the proposed measure to be taken, and receiving, in response to the sent requests, the proposed measure to be taken from each of the devices.

In an embodiment, the request sent to the device serving said at least one radio cell and to the device serving said at least one neighbouring cell for the proposed measure to be taken comprises one or more of: a unique identifier of the device serving the cell indicated to be subjected to the radio traffic, a description of a radio traffic overload event occurring including time when the event is predicted to occur, severity and duration of the radio traffic overload event occurring, an indication of which slice or slices will experience the radio traffic overload event, one or more channels that will experience the overload event, and an indication of whether the radio traffic overload event occurs in downlink, uplink or both.

In an embodiment, neighbouring radio cells are identified from a neighbour relation table (NRT).

In an embodiment, it is detected from the acquired radio traffic capacity utilization metrics that a radio traffic overload event is indicated to occur in said at least one radio cell among the group of radio cells.

In an embodiment, the radio traffic event is detected to occur if the acquired radio traffic capacity utilization metric exceeds a radio traffic load threshold value at a current instant in time or is expected to exceed a radio traffic load threshold value at a later instant in time.

In an embodiment, the determining of the selected measure to be taken for mitigating radio traffic overload of said at least one radio cell comprises selecting, from the proposed measures, the measure which mitigates the radio traffic overload in said at least one radio cell the most, while not causing radio traffic load in said at least one neighbouring radio cell to increase, as indicated by the acquired radio traffic capacity utilization metric of each of the group of radio cells.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated.

### BRIEF DESCRIPTION OF THE DRAWINGS

Aspects and embodiments are now described, by way of example, with reference to the accompanying drawings, in which:

FIG. 1 schematically illustrates a wireless communication network in which embodiments may be implemented;

FIG. 2 shows a signalling diagram illustrating a method of enabling mitigation of radio traffic overload in at least one radio cell among a group of radio cells according to an embodiment;

FIG. 3 shows a signalling diagram illustrating a method of enabling mitigation of radio traffic overload in at least one radio cell among a group of radio cells according to another embodiment;

FIG. 4 shows a signalling diagram illustrating a method of enabling mitigation of radio traffic overload in at least one radio cell among a group of radio cells according to a further embodiment;

FIG. 5 illustrates a supervising device exemplified in the form of an Operations Support System (OSS) according to an embodiment; and

FIG. 6 illustrates a device exemplified in the form of a radio base station (RBS) according to an embodiment.

### DETAILED DESCRIPTION

The aspects of the present disclosure will now be described more fully hereinafter with reference to the accompanying drawings, in which certain embodiments of the invention are shown.

These aspects may, however, be embodied in many different forms and should not be construed as limiting; rather, these embodiments are provided by way of example so that this disclosure will be thorough and complete, and to fully convey the scope of all aspects of invention to those skilled in the art. Like numbers refer to like elements throughout the description.

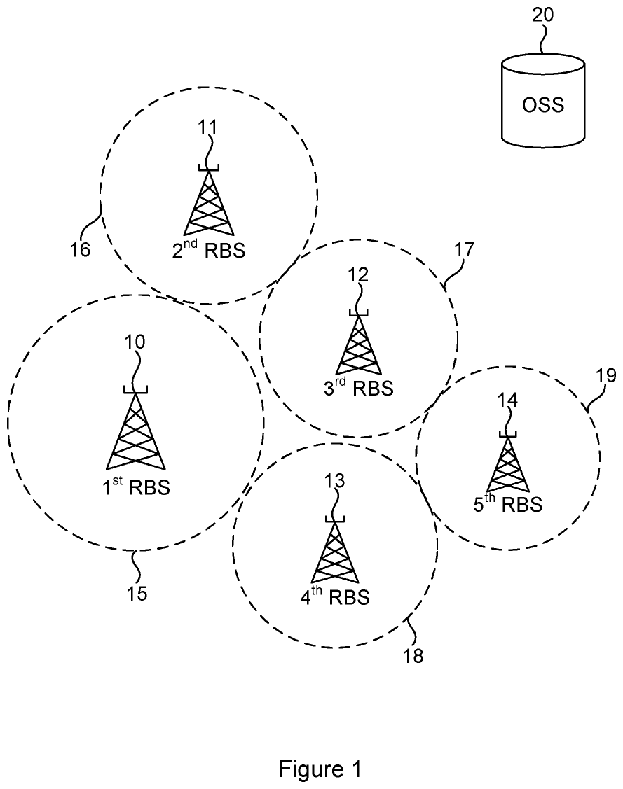

FIG. 1 schematically illustrates a wireless communication network in which embodiments may be implemented, where a radio access network (RAN) comprises five radio base stations (RBSs) 10-14 each serving a respective radio cell 15-19 in which a plurality of UEs (not shown) roams. A UE may be embodied in the form of e.g. smart phones, tablets, connected vehicles. Illustrated in FIG. 1 is also a core network device/system 20, such as for instance a Network Data Analytics Function (NWDAF) or an Operations Support System (OSS) which may consist of a single node or a combination of nodes, typically connected to each RBS 10-14.

The OSS may for instance be responsible for providing network analysis information upon request from different network functions, for instance from the RBSs 10-14. For example, an RBS may request specific analysis information on the load level of a particular network slice. It is noted that the core network in practice comprises a great variety of entities and devices. However, for brevity only the OSS is shown.

As previously mentioned, when a cell or a part of a cell is suffering from—or is approaching—radio traffic overload, an RBS will typically select a strategy for mitigating the traffic overload occurring in the cell it is serving. For instance, it may be envisaged that first RBS 10 decides to handover a plurality of UEs from the cell 15 it is serving to the cell 16 served by second RBS 11. However, if the cell 16 of the second RBS 11 is on the verge of being overloaded while for instance the cell 17 served by third RBS 12 is underutilized, then the overload mitigating strategy of the first RBS 10 is not a preferred strategy.

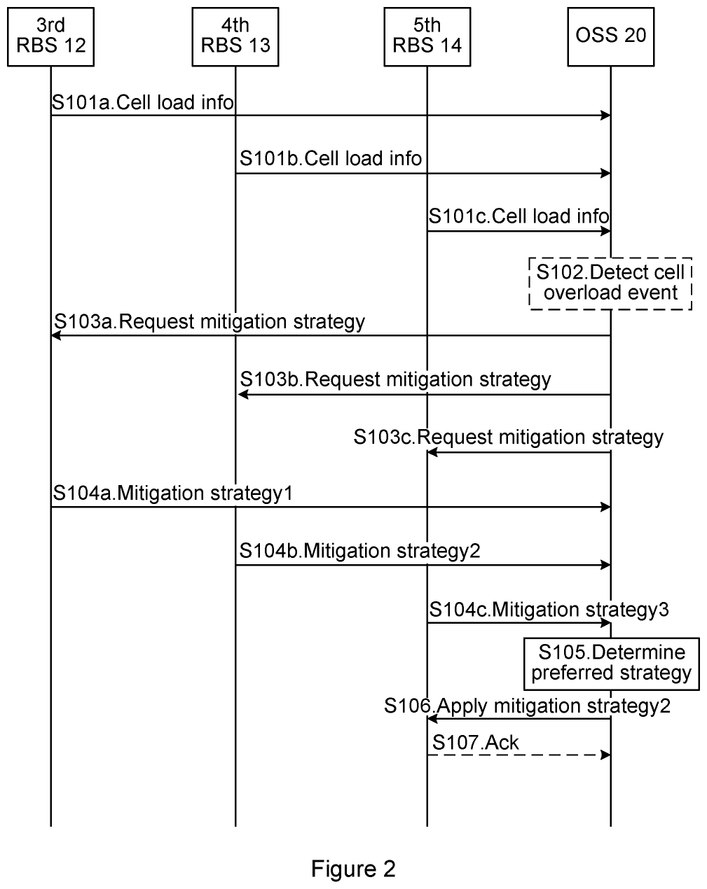

FIG. 2 shows a signalling diagram illustrating a method of enabling mitigation of radio traffic overload in at least one radio cell among a group of radio cells. In this embodiment, a core network device/system exemplified in the form of the OSS 20 will be the supervising device for determining which strategy to be selected for mitigating radio traffic overload in a cell. However, it should be noted that the supervising device may be located in the RAN.

In a first step, the OSS 20 acquires cell load information for all or a subset of the cells 15-19 in FIG. 1. Typically, each RBS 10-14 continuously reports the cell load information for the cell it is serving to the OSS 20. In this exemplifying embodiment, it is illustrated that the third RBS 12, the fourth RBS 13 and the fifth RBS 14 in steps S101a-S101c reports the cell load information to the OSS 20 in steps S101a, S101b and S101c.

The cell load information comprises a radio traffic capacity utilization metric indicating data capacity which is currently being utilized in the cell, or in different parts of the cell.

The OSS 20 continuously analyses the received radio traffic capacity utilization metric to determine whether or not any of the cells 15-19 shows indications of being overloaded, or if any one of the cells in fact is overloaded. The analysis may include predicting that the cell will become overloaded in the future using for example a machine learning model fit for time series analysis—for example an artificial Recurrent Neural Network (RNN)-based Long Short-Term Memory (LSTM) network. This LSTM network will act as a binary classifier, indicating a future overload event or not, given a time series of radio traffic capacity utilization as input.

The received radio traffic capacity utilization metric may be defined as ratio between currently utilized traffic capacity of the cell and total traffic capacity of the cell.

Further, it is envisaged that the cell load information may comprise a respective radio traffic capacity utilization metric for different parts, or slices, of a cell where resources are shared. In an example, it is envisaged that a cell shares resources between five slices, where the cell load information could define that slice1 utilizes 2% of the cell capacity, slice2 utilizes 14% of the cell capacity, slice3 utilizes 24% of the cell capacity, and so on. That is, it is possible for the OSS 20 to assess any overload issues on a sub-cell level.

Moreover, it may be envisaged that one radio traffic capacity utilization metric is given for UL traffic while another is given for DL traffic. The OSS 20 will typically hold a database comprising the radio traffic capacity utilization metric(s) for the different cells.

At some point, the OSS 20 detects or predicts—for example using a machine learning model such as LSTM or random forests, etc.—that a radio traffic overload situation occurs, or is about to occur, based on the radio traffic capacity utilization metrics received in steps S101a-S101c.

In this example, the OSS 20 detects in step S102 from the radio traffic capacity utilization metric received from the fifth RBS 14 that an overload is to occur in the cell 19 served by the fifth RBS 14. Since only the neighbouring cells 17, 18 are affected by a potential overload in fifth cell 19 (and not first cell 15 and second cell 16), the OSS 20 will in steps S103a-S103c send requests to the RBSs 12-14 affected by the overload to propose a measure to be taken for mitigating the radio traffic overload indicated to occur in the first cell 19. The measure of each RBS to be taken for mitigating the radio traffic overload indicated to occur in the first cell 19 will in the following be referred to as a mitigation strategy. It may be envisaged that a mitigation strategy of only one neighbouring RBS is acquired along with the mitigation strategy of the RBS 14 indicated to be subjected to overload, for instance in a scenario where not all neighbouring RBSs are capable of providing a mitigation strategy.

Even though in this embodiment it is describe that the OSS 20 is triggered to send the request for mitigation strategies after having detected that an overload indeed is indicated to be occurring in the fifth cell 19, it may be envisaged that the OSS 20 arbitrarily requests mitigation strategies without first having detected an overload situation (i.e. without performing step S102). In another example, the request for mitigation strategies may be triggered by the OSS 20 receiving a higher-level directive from the core network for instance for guiding decision processes in the core network; e.g. as a change in service-level agreement (SLA) of one or more subscribers.

Regardless of how the process is triggered, the OSS 20 may identify the neighbouring cells of a given cell by turning to a so-called neighbour relation table (NRT), which contains information about the neighbouring cells for a given cell (this is standardized and available for LTE and 5G networks). Alternatively, the OSS 20 may receive a higher-level directive identifying the neighbouring RBSs

In reply to receiving the requests in steps S103a-S103c, the respective RBS 12, 13, 14 responds with a proposed mitigation strategy in steps S104a-S104c and the OSS 20 determines in step S105 from the received mitigation strategies and the radio traffic capacity utilization metrics received in steps S101a-S101c which one is the most preferred, and finally instructs the fifth RBS 14 to apply the most preferred mitigation strategy in the fifth cell 19 in step S106. In order to determine the preferred strategy, OSS may be guided by the SLA specification, or predictions of the network state or the effect on Key Performance Indicators (KPIs) derived by ML models (possibly using similar methods as in [0041]) or statistical methods (Markov decision process or similar). The actual process may also involve various machine reasoning techniques for conflict resolution, constraint solving or satisfiability. As further shown in FIG. 2, the fifth RBS 14 may respond to the received instruction by sending a confirming acknowledgement to the OSS 20 in step S107.

Advantageously, with this embodiment, by collecting mitigation strategies of all (or at least most of) concerned cells, a best cell overload-mitigation strategy is determined given actual circumstances —as indicated by the acquired radio traffic capacity utilization metrics—rather than necessarily selecting the mitigation strategy proposed by the RBS the cell of which is subjected to overload. As a result, an informed decision is taken on the best strategy to apply.

It should be noted that if the OSS 20 would have detected in step S102 that an overload situation is to occur in for instance the third cell 17, the OSS 20 would have requested a mitigation strategy from all the RBSs 10-14, since they all constitute neighbours to the third cell 17 and thus be affected by an overload situation occurring in the third cell 17.

In this example, it is assumed that each RBS reports the cell load information for the corresponding cell. However, this could alternatively be performed by one or more specialized agents implemented in the RAN where each agent handles one or more cells.

Again with reference to FIG. 2, a request for a mitigation strategy sent from the OSS 20 in steps S103a-S103c may comprise:
a unique identifier of the RBS serving the cell indicated to be subjected to overload (or of the corresponding above-mentioned specialized agent). If there is one-to-one mapping between the RBS and a cell, then the identifier could be the Cell Global Identification (CGI) or Cell Identifier (cell-ID), which are globally unique values for each cell. If there is a one-to-many mapping, then the RBS (or agent) can have the CGI or cell-ID of one of the many cells it is managing, or an aggregation of all the CGIs or cell-IDs;
a description of the type of cell overload to occur (referred to in the following as a cell overload event) that includes the time when the event is predicted to occur (if time is o then the event is currently ongoing), and optionally the estimated severity and duration of the event;
an indication of which slice (or slices) will experience the cell overload event and the channel that will experience the overload event (UL/DL/both).

When the third RBS 13, the fourth RBS 14 and the fifth RBS 14 receive the request for a mitigation strategy in steps S103a, S103b and S103c, respectively, each RBS will create a strategy taking into account conditions prevailing in the corresponding cell 17, 18, 19. Creation of a strategy can be based on historical data, e.g. by means of using a statistical method. For example, if a particular RBS has created a specific strategy for 80% of the time that has proven successful, then it creates and suggests a similar strategy. In another example, creation of a strategy can be based on a machine learning model, which based on the data contained on the mitigation strategy request suggests the most suitable strategy. The model is trained on historical data of strategy creation from the particular RBS.

The creation of the strategy depends on the particular cell overload event, as well as the experience of the RBS itself. If for instance the duration of the event is short and the particular RBS was successful in the past by creating a strategy involving e.g. temporarily modifying UL/DL ratio, then the RBS can choose this strategy over others since it historically has proven successful.

A longer duration of the cell overload event could result in the RBS creating a different strategy, such as for example using handover to a smaller neighbouring cell for the most active UEs. The respective chosen strategy is then communicated to the OSS 20 as illustrated in steps S104a-S104c.

Further with reference to FIG. 2, when the OSS 20 in step S105 determines the “best” strategy to apply in step S106, the OSS 20 takes into account effects that the determined mitigation strategy will have on the cell experiencing overload (in this example the fifth cell 19) in which cell the mitigation strategy effectively is applied, but also the effects that the strategy which is being applied to the fifth cell 19 will have on the neighbouring third cell 17 and fourth cell 18. Typically, the desire is to have the maximum positive impact on the fifth cell 19 in which the mitigation strategy is applied, while minimizing negative impact on the third cell 17 and the fourth cell 18 as a consequence of the mitigation strategy being applied in the fifth cell 19.

Typically, the OSS 20 will in step Sins select, from the proposed measures/mitigation strategies of the RBSs, the measure which mitigates the radio traffic overload in the fifth cell 19 the most, while not causing radio traffic load in the neighbouring cells 17, 18 to increase, as indicated by the acquired radio traffic capacity utilization metric of each of the group of cells 17, 18, 19.

A number of parameters may be taken into account when determining the impact that the determined mitigation strategy will have; a reduction in the radio traffic capacity utilization metric in the overloaded cell 19 is a positive impact, while an increase in the metric in the third cell 17 and the fourth cell 18 is a negative impact.

Advantageously, negative impacts on neighbouring cells caused by local measures being taken in a cell being subjected to traffic overload is prevented.

In the following, an exemplifying scenario is discussed to illustrate how the OSS 20 may determine the impact that a mitigation strategy will have on a neighbouring cell.

After the third RBS 12, the fourth RBS 13 and the fifth RBS 14 has reported radio traffic capacity utilization metrics for the cell 17, 18, 19 that the respective RBS is serving (or for one or more slices of the cell), the OSS 20 will in step S102 determine whether or not an overload situation is approaching.

In the following example, it is assumed that three network slices (Slice 1, Slice 2 and Slice 3) are spanning the third cell 17, the fourth cell 18 and the fifth cell 19, and that a radio traffic capacity utilization metric is reported for each slice. In practice, each or a combination of network slices typically serve an enterprise customer or private individuals. For example, Slices 1 and 3 may serve some mission-critical enterprise application or applications such as teleoperation, e.g. remote surgery, remote driving, etc., while Slice 2 may serve private mobile subscribers which for instance use mobile broadband type of services to surf on their UEs.

Assuming that the following metrics are reported by the fifth RBS 14 in step S101c, where the numbers given specify current radio traffic utilization in relation to maximum radio traffic capacity of each slice in uplink and downlink, respectively:
Timestamp: 2020 Nov. 3, 22:17:05
Slice 1 applies an ultra-reliable low latency communication (uRLLC) approach; 85% UL, 80% DL;
Slice 2 applies an enhanced mobile broadband (eMBB) approach; 15% UL, 10% DL;
Slice 3 also applies a uRLLC approach; 90% UL, 30% DL.

In other words:
for Slice 1, 85% of the UL capacity of the slice is utilized, while 80% of the DL capacity of the slice is utilized;
for Slice 2, 15% of the UL capacity of the slice is utilized, while 10% of the DL capacity of the slice is utilized; and
for Slice 3, 90% of the UL capacity of the slice is utilized, while 30% of the DL capacity of the slice is utilized.

Now, the OSS 20 concludes in step S102 from the above-described cell load information received in step S101c that overloading of Slice 3 will occur by an event occurring in the fifth cell 19 at a given time t1, the event being for instance that further UEs using Slice 3 will be added to the fifth cell 19 at t1.

As can be intuitively concluded: Slice 3 is likely to have capacity to handle further UEs in the downlink since only 30% of the maximum downlink capacity of the slice utilized, but not in the uplink since the current utilization of the slice in the uplink amounts to 90% of the maximum uplink capacity for the slice.

The OSS 20 will thus request mitigation strategies in steps S103a-S103c and in response thereto receive a mitigation strategy from each one of the RBSs 12, 13, 14.

In this exemplifying embodiment, the following mitigation strategies are proposed by the RBSs 12, 13, 14:
3^{rd} RBS 12 proposes strategy1, which is to change the UL-to-DL ratio, and allocate some more resources to uplink as downlink is relatively under-utilized for Slice 3;
4^{th} RBS 13 proposes strategy2, which includes “borrowing” bandwidth from Slice 2 to serve Slice 3, since Slice 2 is quite under-utilized; and
5^{th} RBS 14 proposes strategy3, which dictates that in order to provide overload mitigation, the fifth RBS 13 will hand over some of its UEs to the third cell 17, which will have as an effect that the expected overload event at time t1 caused by UEs being added to the fifth cell 18 and Slice 3 likely will not occur.

Now, for the OSS 20 to determine the most preferred mitigation strategy to be applied, the OSS 20 needs to analyse the radio traffic capacity utilization metrics received in steps S101a-S101c to determine whether or not the RBSs 12, 13, 14 are negatively affected by a proposed mitigation strategy.

The OSS 20 will thus, taking into account the mitigation strategies received in steps S104a-S104c and the radio traffic capacity utilization metrics received in steps S101a-S101c, conclude the following:
strategy1 is not preferred, since the third RBS 12 and the fourth RBS 13 indicate with the radio traffic capacity utilization metrics reported in steps S101a, S101b that the third cell 17 and the fourth cell 18 both are prone to be overloaded in uplink and downlink within t1 and it is thus likely that UEs will be handed over from these RBSs to the fifth RBS 14;
strategy3 does not appear to be attractive as the load levels indicated with the radio traffic capacity utilization metrics reported in step S101a implies that the third cell 17 already is operating on a high capacity-utilization level and could be overloaded if the third RBS is to serve further UEs handed over by the fifth RBS 14; while
strategy2 appears to be the most preferred strategy since the capacity of Slice 2 is under-utilized and resources of Slice 2 thus could be allocated to Slice 3 (without having any negative impact on any of the cells 17, 18, 19).

As a result, the OSS 20 will send an instruction in step S106 to the fifth RBS 14 to apply the mitigation strategy determined in step S105 to be the best strategy; in other words strategy2 proposed by the fourth RBS 13 stipulating that traffic resources are re-allocated from Slice 2 to Slice 3 thereby increasing the maximum capacity of Slice 3 without negatively affecting any of the RSs 12, 13, 14.

In an embodiment, the OSS 20 determines in step S105 which mitigation strategy is most preferred by applying machine learning (ML). For instance, a time-series analysis approach may be applied that uses ML and a recurrent neural network (RRN) such as a long short-term memory (LSTM) architecture. This type of neural network may when trained properly use input data in the form of the reported radio traffic capacity utilization metrics for one or more cells or slices of a cell to predict whether or not a traffic overload event will occur. Alternatively, less sophisticated time series analysis methods may be used, for example time series regression.

In a more straightforward embodiment, the OSS 20 determines whether or not current radio traffic capacity utilization for a cell or slice exceeds a cell load threshold value, for instance above 85% of maximum capacity of the cell; if so a cell overload event is considered to occur.

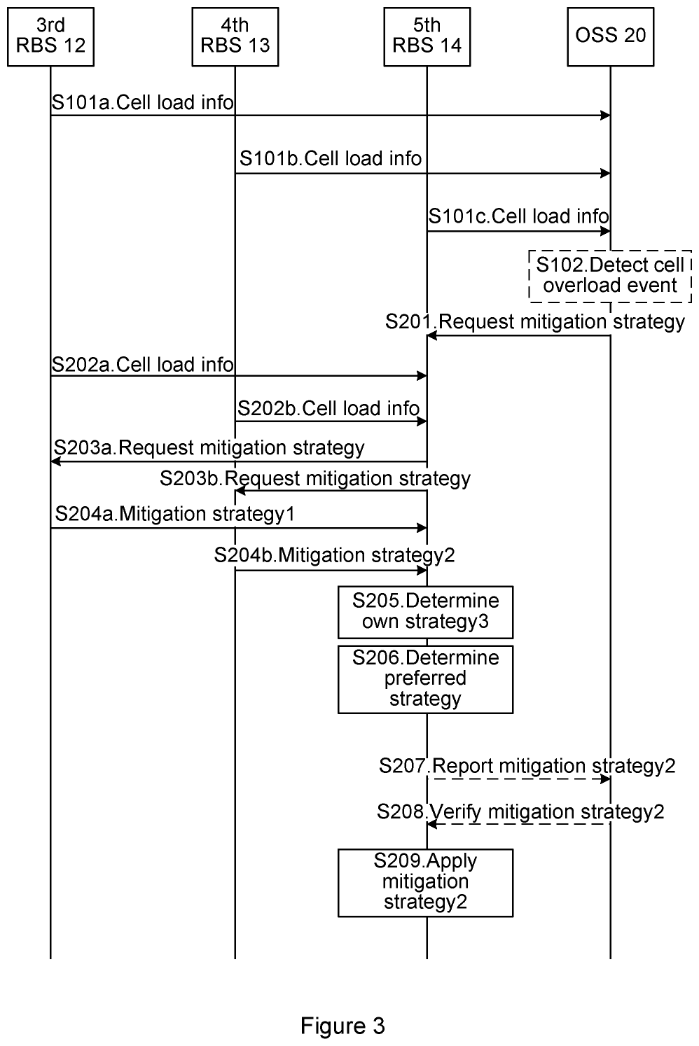

In another embodiment, with reference to FIG. 3, instead of having the OSS 20 determine which mitigation strategy is most preferred, one or more of the RBSs 12, 13, 14 will determine which strategy is most preferred. As previously discussed, the RBSs may create a strategy based on historical data, e.g. by means of using a statistical method. For example, if a particular RBS has created a specific strategy for 80% of the time that has proven successful, then it creates and suggests a similar strategy. In another example, creation of a strategy can be based on a machine learning model, which based on the data contained on the mitigation strategy request suggests the most suitable strategy. The model is trained on historical data of strategy creation from the particular RBS.

In this embodiment, after the utilization metrics are reported in steps S101a-S101c, and the OSS 20 optionally determines in step S102 from the metrics that mitigation strategies should be requested (as previously discussed, this may be triggered without the metrics indicating a need for strategies), the OSS 20 sends a request for a mitigation strategy to one of the RBSs in step S201, in this case the fifth RBS 14.

Now, when the fifth RBS 14 receives the request for a mitigation strategy in step S201, the fifth RBS 14 will acquire the radio traffic capacity utilization metrics from the third RBS 13 and the fourth RBS 14 in steps S202a and S202b (as previously performed by the OSS 20 in steps S101a and S101b, respectively), as well as the mitigation strategies of the third RBS 12 and the fourth RBS 14 in steps S203a, S204a and steps S204a, S204b (as previously performed by the OSS 20 in steps S103a, S104a and S103b, S104b, respectively) as indicated in the NRT.

Further, the fifth RBS 14 determines in step S205 its own mitigation strategy.

Thereafter, the fifth RBS 14 determines in step S206 which mitigation strategy is most preferred—i.e. strategy2—based on the radio traffic capacity utilization metrics of each cell. The preferred mitigation strategy may further be communicated to the OSS 20 in step S207, which may verify that the preferred mitigation strategy is suitable (based on the previously reported radio traffic capacity utilization metrics) in step S208 and inform the fifth RBS 14 accordingly which finally applies the preferred mitigation strategy in step S209. It may alternatively be envisaged that the preferred mitigation strategy is applied in step S209 without having the OSS 20 verify that it is suitable.

In an alternative embodiment, instead of having the fifth RBS 14 determine which preferred strategy to apply, the RBSs 12, 13, 14 share the mitigation strategies among each other along with the radio traffic capacity utilization metrics of each cell 17, 18, 19. Thereafter, each RBS votes for a preferred strategy, and the mitigation strategy receiving most votes is selected as the preferred strategy to be applied by the fifth RBS 14 for the fifth cell 19.

Advantageously, with the embodiments discussed, mitigation strategies of neighbouring RBSs are taken into to determine the best strategy for dealing with a current or prospective data traffic overload issue of a particular cell. Instead of unilaterally enforcing a local overload mitigation strategy that may negatively affect neighbouring cells and incur service degradation and/or great costs, a mechanism is proposed which collects and assesses strategies of a group of RBSs in order to enforce a collectively optimal strategy. This can be achieved either upon an OSS encountering an overload event, or by the OSS pre-emptively triggering a preparation for a predicted future overload event. In addition, allowing the RBSs to propose a strategy provides for a decentralized approach.

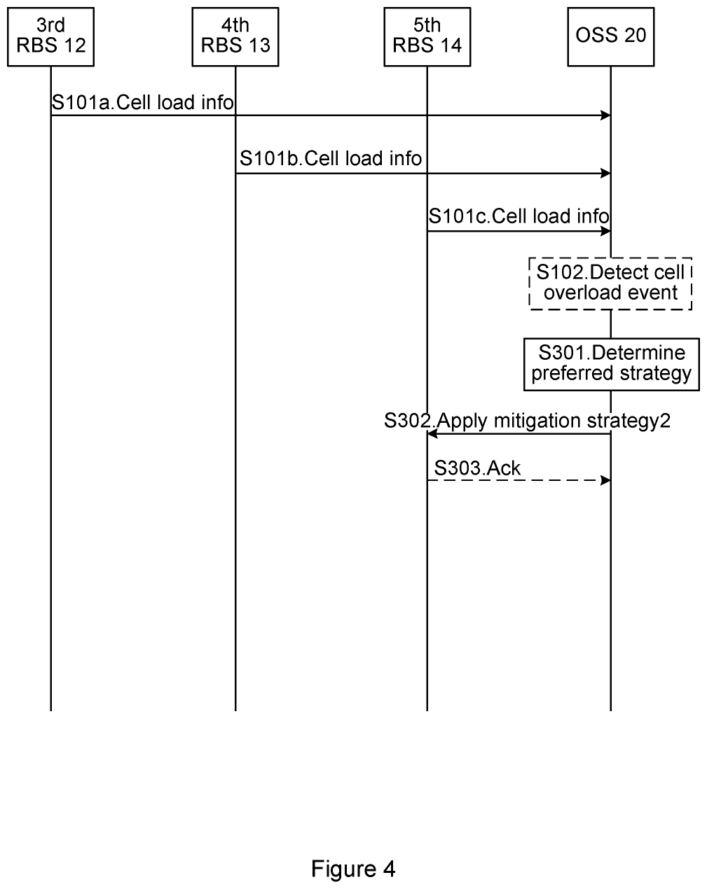

In a further embodiment, with reference to FIG. 4, after having received the radio traffic capacity utilization metrics in step S101a-S101c and optionally detected a cell overload event in step S102, the OSS 20 will in this particular embodiment itself determine a proposed measure (i.e. mitigation strategy) to be taken for mitigation traffic overload in the fifth cell 19. In other words, the OSS 20 will determine a preferred mitigation strategy to be applied based on the previously discussed reported traffic utilization metrics.

In line with previous embodiments, the OSS 20 may determine that strategy2 is the preferred strategy and in step S302 instruct the fifth RBS 14 to apply strategy2 in the fifth cell 19. This may be acknowledged by the fifth RBS 14 in step S303, or may indeed determine that a new strategy, e.g. strategy4 is the best strategy to apply in which case the OSS 20 instructs the fifth RBS 14 to apply strategy4 in step S302.

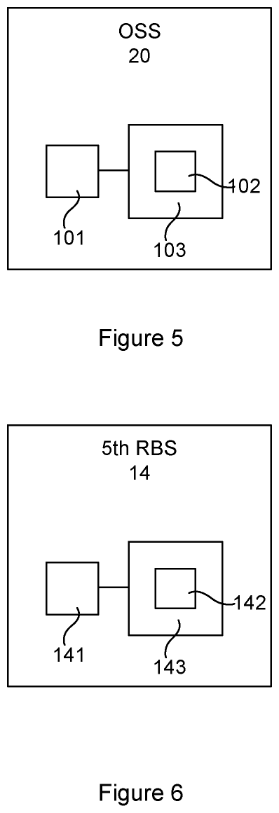

FIG. 5 illustrates an OSS 20 configured to enable mitigation of radio traffic overload in at least one radio cell among a group of radio cells according to an embodiment. The steps of the method performed by the OSS 20 are in practice performed by a processing unit 101 embodied in the form of one or more microprocessors arranged to execute a computer program 102 downloaded to a suitable storage volatile medium 103 associated with the microprocessor, such as a Random Access Memory (RAM), or a non-volatile storage medium such as a Flash memory or a hard disk drive. The processing unit 101 is arranged to cause the OSS 20 to carry out the method according to embodiments when the appropriate computer program 102 comprising computer-executable instructions is downloaded to the storage medium 103 and executed by the processing unit 101. The storage medium 103 may also be a computer program product comprising the computer program 102. Alternatively, the computer program 102 may be transferred to the storage medium 103 by means of a suitable computer program product, such as a Digital Versatile Disc (DVD) or a memory stick. As a further alternative, the computer program 102 may be downloaded to the storage medium 103 over a network. The processing unit 101 may alternatively be embodied in the form of a digital signal processor (DSP), an application specific integrated circuit (ASIC), a field-programmable gate array (FPGA), a complex programmable logic device (CPLD), etc.

FIG. 6 illustrates fifth RBS 14 serving at least one radio cell being configured to enable mitigation of radio traffic overload in said at least one radio cell among a group of radio cells according to an embodiment. The steps of the method performed by the fifth RBS 14 are in practice performed by a processing unit 141 embodied in the form of one or more microprocessors arranged to execute a computer program 142 downloaded to a suitable storage volatile medium 143 associated with the microprocessor, such as a RAM, or a non-volatile storage medium such as a Flash memory or a hard disk drive. The processing unit 141 is arranged to cause the fifth RBS 14 to carry out the method according to embodiments when the appropriate computer program 142 comprising computer-executable instructions is downloaded to the storage medium 143 and executed by the processing unit 141. The storage medium 143 may also be a computer program product comprising the computer program 142. Alternatively, the computer program 142 may be transferred to the storage medium 143 by means of a suitable computer program product, such as a DVD or a memory stick. As a further alternative, the computer program 142 may be downloaded to the storage medium 143 over a network. The processing unit 141 may alternatively be embodied in the form of a DSP, an ASIC, an FPGA, a CPLD, etc.

The aspects of the present disclosure have mainly been described above with reference to a few embodiments and examples thereof. However, as is readily appreciated by a person skilled in the art, other embodiments than the ones disclosed above are equally possible within the scope of the invention, as defined by the appended patent claims.

Thus, while various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1-43. (canceled)

44. A method of a supervising device of enabling mitigation of radio traffic overload in at least one radio cell among a group of radio cells, comprising:
acquiring a radio traffic capacity utilization metric of each of the group of radio cells;
acquiring a proposed measure to be taken for mitigating radio traffic overload of said at least one radio cell from a device serving said at least one radio cell and from a device serving at least one of its neighbouring radio cells in the group;
determining, based on the acquired radio traffic capacity utilization metrics and the acquired proposed measures to be taken, a selected measure to be taken for mitigating radio traffic overload of said at least one radio cell; and
instructing the device serving said at least one radio cell to apply the selected measure for mitigating radio traffic overload of said at least one radio cell.

45. The method of claim 44, wherein the acquiring of a proposed measure to be taken for mitigating radio traffic overload of said at least one radio cell comprises:
sending a request, to the device serving said at least one radio cell and to the device serving said at least one neighbouring cell for the proposed measure to be taken; and
receiving, in response to the sent requests, the proposed measure to be taken from each of the devices.

46. The method of claim 45, wherein the request sent to the device serving said at least one radio cell and to the device serving said at least one neighbouring cell for the proposed measure to be taken comprises one or more of: a unique identifier of the device serving the cell indicated to be subjected to the radio traffic, a description of a radio traffic overload event occurring including time when the event is predicted to occur, severity and duration of the radio traffic overload event occurring, an indication of which slice or slices will experience the radio traffic overload event, one or more channels that will experience the overload event, and an indication of whether the radio traffic overload event occurs in downlink, uplink or both.

47. The method of claim 44, wherein the determining of the selected measure to be taken for mitigating radio traffic overload of said at least one radio cell comprises:
selecting, from the proposed measures, the measure which mitigates the radio traffic overload in said at least one radio cell the most, while not causing radio traffic load in said at least one neighbouring radio cell to increase, as indicated by the acquired radio traffic capacity utilization metric of each of the group of radio cells.

48. The method of claim 44, wherein the determining of the selected measure to be taken for mitigating radio traffic overload of said at least one radio cell is based on machine learning.

49. A method of a device serving at least one radio cell of enabling mitigation of radio traffic overload in said at least one radio cell among a group of radio cells, comprising:
receiving, from a supervising device, a request for a proposed measure to be taken for mitigating radio traffic overload of said at least one radio cell;
acquiring a radio traffic capacity utilization metric of at least one neighbouring radio cell;
acquiring a proposed measure to be taken for mitigating radio traffic overload of said at least one radio cell from a device serving at least one neighbouring radio cell;
determining, a measure to be taken for mitigating radio traffic overload of said at least one radio cell;
determining, based on the acquired radio traffic capacity utilization metric, the acquired proposed measure to be taken for the at least one neighbouring cell and the determined measure to be taken for said at least one radio cell, a selected measure to be taken for mitigating radio traffic overload of said at least one radio cell; and
applying the selected measure for mitigating radio traffic overload of said at least one radio cell.

50. The method of claim 49, wherein the acquiring of a proposed measure to be taken for mitigating radio traffic overload of said at least one radio cell comprises:
sending a request, to the device serving said at least one neighbouring cell for the proposed measure to be taken; and
receiving, in response to the sent request, the proposed measure to be taken from the device.

51. The method of claim 50, wherein the request received from the supervising device and sent to the device serving said at least one neighbouring cell comprises one or more of: a unique identifier of the device serving the cell indicated to be subjected to the radio traffic, a description of a radio traffic overload event occurring including time when the event is predicted to occur, severity and duration of the radio traffic overload event occurring, an indication of which slice or slices will experience the radio traffic overload event, one or more channels that will experience the overload event, and an indication of whether the radio traffic overload event occurs in downlink, uplink or both.

52. The method of claim 49, wherein the determining of the selected measure to be taken for mitigating radio traffic overload of said at least one radio cell comprises:
selecting, from the proposed measures and the determined measure, the measure which mitigates the radio traffic overload in said at least one radio cell the most, while not causing radio traffic load in said at least one neighbouring radio cell to increase, as indicated by the acquired radio traffic capacity utilization metric of each of the group of radio cells.

53. The method of claim 49, wherein the determining of the measure to be taken for mitigating radio traffic overload of said at least one radio cell and/or the determining of the selected measure to be taken for mitigating radio traffic overload of said at least one radio cell is based on machine learning.

54. A supervising device configured to enable mitigation of radio traffic overload in at least one radio cell among a group of radio cells, the supervising device comprising a processing unit and a memory, said memory containing instructions executable by said processing unit, whereby the supervising device is configured to:
acquire a radio traffic capacity utilization metric of each of the group of radio cells;
acquire a proposed measure to be taken for mitigating radio traffic overload of said at least one radio cell from a device serving said at least one radio cell and from a device serving at least one of its neighbouring radio cells in the group;
determine, based on the acquired radio traffic capacity utilization metrics and the acquired proposed measures to be taken, a selected measure to be taken for mitigating radio traffic overload of said at least one radio cell; and to
instruct the device serving said at least one radio cell to apply the selected measure for mitigating radio traffic overload of said at least one radio cell.

55. The supervising device of claim 54, being further configured by said instructions to, when acquiring a proposed measure to be taken for mitigating radio traffic overload of said at least one radio cell:
send a request, to the device serving said at least one radio cell and to the device serving said at least one neighbouring cell for the proposed measure to be taken; and
receive, in response to the sent requests, the proposed measure to be taken from each of the devices.

56. The supervising device of claim 55, wherein the request sent to the device serving said at least one radio cell and to the device serving said at least one neighbouring cell for the proposed measure to be taken is configured to comprise one or more of: a unique identifier of the device serving the cell indicated to be subjected to the radio traffic, a description of a radio traffic overload event occurring including time when the event is predicted to occur, severity and duration of the radio traffic overload event occurring, an indication of which slice or slices will experience the radio traffic overload event, one or more channels that will experience the overload event, and an indication of whether the radio traffic overload event occurs in downlink, uplink or both.

57. The supervising device of claim 54, being further configured by said instructions to:
detect from the acquired radio traffic capacity utilization metrics that a radio traffic overload event is indicated to occur in said at least one radio cell among the group of radio cells.

58. The supervising device of claim 54, being further configured by said instructions to, when determining the selected measure to be taken for mitigating radio traffic overload of said at least one radio cell:
select, from the proposed measures, the measure which mitigates the radio traffic overload in said at least one radio cell the most, while not causing radio traffic load in said at least one neighbouring radio cell to increase, as indicated by the acquired radio traffic capacity utilization metric of each of the group of radio cells.

59. A device serving at least one radio cell being configured to enable mitigation of radio traffic overload in said at least one radio cell among a group of radio cells, the device comprising a processing unit and a memory, said memory containing instructions executable by said processing unit, whereby the device is configured to:
receive, from a supervising device, a request for a proposed measure to be taken for mitigating radio traffic overload of said at least one radio cell;
acquire a radio traffic capacity utilization metric of at least one neighbouring radio cell;
acquire a proposed measure to be taken for mitigating radio traffic overload of said at least one radio cell from a device serving at least one neighbouring radio cell;
determine, a measure to be taken for mitigating radio traffic overload of said at least one radio cell;
determine, based on the acquired radio traffic capacity utilization metric, the acquired proposed measure to be taken for the at least one neighbouring cell and the determined measure to be taken for said at least one radio cell, a selected measure to be taken for mitigating radio traffic overload of said at least one radio cell; and to
apply the selected measure for mitigating radio traffic overload of said at least one radio cell.

60. The device of claim 59, being further configured by said instructions to:
acquire a confirmation from the supervising device that the determined selected measure to be taken should be applied.

61. The device of claim 59, being further configured by said instructions to, when acquiring a proposed measure to be taken for mitigating radio traffic overload of said at least one radio cell comprises:
send a request, to the device serving said at least one neighbouring cell for the proposed measure to be taken; and
receive, in response to the sent request, the proposed measure to be taken from the device.

62. The device of claim 61, wherein the request received from the supervising device and sent to the device serving said at least one neighbouring cell is configured to comprise one or more of: a unique identifier of the device serving the cell indicated to be subjected to the radio traffic, a description of a radio traffic overload event occurring including time when the event is predicted to occur, severity and duration of the radio traffic overload event occurring, an indication of which slice or slices will experience the radio traffic overload event, one or more channels that will experience the overload event, and an indication of whether the radio traffic overload event occurs in downlink, uplink or both.

63. The device of claim 59, further being operative to, when determining the selected measure to be taken for mitigating radio traffic overload of said at least one radio cell:
select, from the proposed measures and the determined measure, the measure which mitigates the radio traffic overload in said at least one radio cell the most, while not causing radio traffic load in said at least one neighbouring radio cell to increase, as indicated by the acquired radio traffic capacity utilization metric of each of the group of radio cells.
